(19) United States
(12) Patent Application Publication
(10) Pub. No.: US 2009/0029137 A1
(43) Pub. Date: Jan. 29, 2009

(54) Method for producing polymer thin film, and polymer thin film

(75) Inventors: Toyoki Kunitake, Wako-shi (JP); Hirohmi Watanabe, Wako-shi (JP)

Correspondence Address: BIRCH STEWART KOLASCH & BIRCH, PO BOX 747, FALLS CHURCH, VA, 22040-0747, US

(73) Assignee: RIKEN, Wako-shi (JP)

(21) Appl. No.: 12/068,246

(22) Filed: Feb. 4, 2008

(30) Foreign Application Priority Data
May 21, 2007 (JP) 2007-134000

(51) Int. Cl. B32B 5/00; B32B 43/00

(52) U.S. Cl. 428/220; 156/344

(57) ABSTRACT

A method for producing a polymer thin film, comprising providing a composition that contains a polymerizable compound having at least two (meth)acryl groups on a support to form a layer, chain-polymerizing the polymerizable compound, and separating the layer from the support. The produced polymer thin film has high strength, flexibility and accuracy.

### BACKGROUND OF THE INVENTION

1. Field of the Invention

The present invention relates to a method for producing a polymer thin film, and to a polymer thin film produced according to the production method.

2. Background Art

Heretofore, various methods for producing self-supporting thin films have been investigated, for which, for example, known are a water surface casting method, and an interfacial reaction method using a silane coupling agent. However, the thin films produced by these methods generally have poor mechanical strength and the accuracy of the thin films produced is limited.

On the other hand, a thin film of biolipid has high accuracy in film formation owing to the self-assembling property that the molecules themselves have, but its mechanical strength is insufficient for use for functional thin films. Accordingly, a thin film of biolipid must have a multi-layered structure, and is therefore not excellent in point of its general practicability.

A Langmuir-Blodgett (LB) method and a layer-by-layer method (LbL lamination method) that are known for thin film formation are complicated, and may often produce aggregates of microcrystalline domains with many defects, and therefore their practicability level is not high. Specifically, according to these methods, it is difficult to produce thins having a large surface area and a high strength.

In general, a thin film, especially a self-supporting thin film may have more surface defects with the increase in the surface area. Many of such self-supporting films may have a porous support serving as a substrate.

Angew. Chem. Int. Ed. 2000, 39, No. 6 describes a method of forming a thin film through ionic adsorption and polymerization of polyethyleneimine on the surface of a self-supporting film (self-assembled monolayer) having a carboxyl group and a methyl group on its surface. However, the method is for polymerizing the self-supporting film and the polyethyleneimine layer adsorbed by the surface of the film. In other words, the method comprises a constitution of polymerizing two layers.

### SUMMARY OF THE INVENTION

An object of the invention is to solve the above-mentioned problems, and to produce a polymer thin film having high strength, flexibility and accuracy.

Taking the above object into consideration, the present inventors have assiduously studied and, as a result, have found that the above problems can be solved by the following means:

(1) A method for producing a polymer thin film, comprising:

providing a composition that contains a polymerizable compound having at least two (meth)acryl groups, on a support, to form a layer,

chain-polymerizing the polymerizable compound having at least two (meth)acryl groups in the layer, and

separating the layer from the support.

(2) A method for producing a polymer thin film, comprising:

providing a sacrifice layer on the surface of a support,

providing a composition that contains a polymerizable compound having at least two (meth)acryl groups, on the surface of the sacrifice layer, to form a layer,

chain-polymerizing the polymerizable compound having at least two (meth)acryl groups, and

removing the sacrifice layer to thereby separate the chain-polymerized layer from the support.

(3) The method for producing a polymer thin film according to (2), wherein the removal of the sacrifice layer is attained by dissolving the sacrifice layer.

(4) The method for producing a polymer thin film according to (3), wherein the sacrifice layer comprises a water-soluble polymer as a main ingredient, and the sacrifice layer is dissolved with water.

(5) The method for producing a polymer thin film according to (4), wherein the water-soluble polymer is selected from the group consisting of polystyrene sulfonate, polyvinyl alcohol, (meth)acrylamide and water-soluble cellulose.

(6) The method for producing a polymer thin film according to any one of (1) to (5), wherein the polymerizable compound having at least two (meth)acryl groups is represented by the following formula:

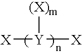

wherein Y represents a polyalcohol-modified group or an amine-modified group, n is an integer of at least 1, m is an integer of at least 0, and X is a group represented by the following formula:

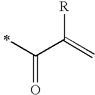

wherein R represents a hydrogen atom or a methyl group, and * indicates the site at which the group bonds to Y.

(7) The method for producing a polymer thin film according to any one of (1) to (6), wherein the composition further contains a chain polymerization initiator.

(8) The method for producing a polymer thin film according to any one of (1) to (7), wherein the chain polymerization is radical polymerization.

(9) The method for producing a polymer thin film according to any one of (1) to (8), wherein the composition has a viscosity, as measured with an E-type viscometer, of at least 0.01 cps.

(10) The method for producing a polymer thin film according to any one of (1) to (9), wherein the composition that contains a polymerizable compound having at least two (meth)acryl groups is layerwise provided on the support according to a spin-coating method or a dip-coating method.

(11) A self-supportable polymer thin film having a thickness of 100 nm or less wherein the polymer is produced by chain-polymerizing a polymerizable compound having at least two (meth)acryl groups.

(12) The self-supportable polymer thin film according to (11), which is produced by the method of any one of (1) to (10).

(13) The self-supportable polymer thin film according to (11) or (12), which has a thickness of 30 nm or less.

(14) The self-supportable polymer thin film according to any one of (11) to (13), which has an aspect ratio of the film size to the film thickness of at least 10⁴.

(15) The polymer thin film according to any one of (11) to (14), which has a strength of at least 10 MPa.

(16) The polymer thin film according to any one of (11) to (15), which has an electric resistance of at least 10¹⁰Ω.

(17) The polymer thin film according to any one of (11) to (16), which contains at least one selected from dye, pigment, metal fine particle, metal oxide fine particle, organic fine particle, organic low-molecular substance, organic polymer, dendrimer, biomolecule, carbon nanotube, fullerene, carbon black and clay mineral.

The present invention has made it possible to obtain a polymer thin film having high strength, flexibility and accuracy. Further, the invention has made it possible to obtain a thin polymer film having those characteristics and having a large surface area.

### BRIEF DESCRIPTION OF THE DRAWINGS

FIG. 1 shows a scheme of the production method for a polymer thin film in Examples of the invention. In FIG. 1, 1 is a substrate, 2 is a sacrifice layer, 3 is a layer of a composition for use in the invention, 4 is a light exposure device, and 5 is a polymer thin film.

FIG. 2 shows SEM pictures taken in Example 1.

### BEST MODE FOR CARRYING OUT THE INVENTION

The contents of the invention are described in detail hereinunder. In this description, the numerical range expressed by the wording “a number to another number” means the range that falls between the former number indicating the lowermost limit of the range and the latter number indicating the uppermost limit thereof.

The method for producing a polymer thin film of the invention comprises providing a composition that contains a polymerizable compound having at least two (meth)acryl groups (this may be hereinafter referred to as “composition for use in the invention”), on a support, to form a layer, and then chain-polymerizing the polymerizable compound having at least two (meth) acryl groups in the layerwise-provided composition, and thereafter separating the layer from the support.

The polymerizable compound having at least two (meth)acryl groups in the invention means a polymerizable compound having at least two acryl groups or a polymerizable compound having at least two methacryl groups, and is preferably a polymerizable compound having at least two acryl groups. For example, the polymerizable compound having at least two (meth)acryl groups includes acryl esters or acrylamides formed by (meth) acryl modification of a polyvalent compound having at least two groups of a hydroxyl group, an amino group, an epoxy group and an iso(thio)cyanate group.

For example, the compound includes those of the following formula:

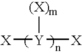

In this, Y represents a polyalcohol-modified group or an amine-modified group. Preferably, Y has at least one group selected from a substituted or unsubstituted alkylene group, and a substituted or unsubstituted arylene group.

n indicates an integer of at least 1, preferably an integer of from 1 to 10.

m indicates an integer of at least 0, preferably an integer of from 1 to 4.

X is a group represented by the following formula:

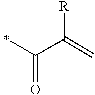

In the formula, R represents a hydrogen atom or a methyl group; * indicates the site at which the group bonds to Y.

Preferably, R is selected depending on the production condition and the use of the film. For example, when the film is desired to slowly cure, then R is preferably a methyl group.

Examples of the compound are R280 (by Mitsui Chemical) and Unidick 5500 (by Dai-Nippon Ink) where n=1 and m=0; PETIA (pentaerythritol acrylate) where n=1 and m=4; Lipoxy H600 (by Showa Highpolymer) where n>2 and m=1, prepared through acryl modification of cresol-type epoxy compound.

One or more different types of polymerizable compounds having at least two (meth) acryl groups may be used either singly or as combined. The compound may be further combined with any other polymerizable/non-polymerizable compound. For example, a polyfunctional acrylate compound and a monofunctional acrylate monomer may be combined. Using the technique may improve the coatability of the film-forming composition.

The polymerizable compound having at least two (meth)acryl groups for use in the invention may be a monomer or an oligomer.

When the compound is a monomer, it is desirable that a substance having no direct relation to chain polymerization (for example, a bulk material) is added to the composition for controlling the viscosity of the composition. Using the technique may increase the viscosity of the composition for use in the invention, thereby further improving the coatability of the composition.

When the compound is an oligomer, it is desirable that the oligomer comprises from 1 to 50 monomer units, more preferably from 1 to 10 monomer unites.

Preferably, the composition for use in the invention has a viscosity, as measured with an E-type viscometer, of at least 0.01 cps, more preferably from 0.1 to 10 cps, even more preferably from 0.5 to 10 cps. Having a viscosity falling within the range, the composition may have better coatability.

Preferably, the composition for use in the invention contains a polymerizable compound having at least two (meth)acryl groups in an amount of at least 30% by weight.

In the invention, the composition is chain-polymerized, and the polymerization method for it is not specifically defined, not overstepping the scope and the spirit of the invention. In the invention, any known chain-polymerization method is employable in a broad range. The chain polymerization includes radical polymerization (including living radical polymerization) and ionic polymerization; and the ionic polymerization includes anionic polymerization (including living anionic polymerization).

In the invention, preferred is polymerization with a chain polymerization initiator; more preferred is a photopolymerization or thermal polymerization with a chain polymerization initiator; even more preferred is photoradical polymerization or thermal radical polymerization with a chain polymerization initiator; still more preferred is photoradical polymerization with a chain polymerization initiator. Also preferably employed in the invention is a method of two-component electron-moving redox reaction.

The photoradical polymerization initiator includes, for example, benzoins, acetophenones, anthraquinones, thioxanthones, ketals, benzophenones, phosphine oxides. Benzoins include, for example, benzoin, benzoin methyl ether, benzoin ethyl ether, benzoin propyl ether, benzoin isobutyl ether. Acetophenones include, for example, acetophenone, 2,2-diethoxy-2-phenylacetophenone, 1,1-dichloroacetophenone, 2-hydroxy-2-methylphenylpropan-1-one, diethoxyacetophenone, 1-hydroxycyclohexyl phenyl ketone, 2-methyl-1-[4-(methylthio)phenyl]-2-morpholinopropan-1-one. Anthraquinones include, for example, 2-ethylanthraquinone, 2-t-butylanthraquinone, 2-chloroanthraquinone, 2-amylanthraquinone. Thioxanthones include, for example, 2,4-diethylthioxanthone, 2-isopropylthioxanthone, 2-chlorothioxanthone. Ketals include, for example, acetophenone dimethyl ketal, benzyldimethyl ketal. Benzophenones include, for example, benzophenone, 4-benzoyl-4′-methyldiphenyl sulfide, 4,4′-bismethylaminobenzophenone. Phosphine oxides include, for example, 2,4,6-trimethylbenzoyldiphenyl phosphine oxide, bis(2,4,6-trimethylbenzoyl)-phenyl phosphine oxide. Concretely, Ciba Specialty Chemicals, Irgacure 184 (1-hydroxycyclohexyl phenyl ketone), Irgacure 907 (2-methyl-1-(4-(methylthio) phenyl)-2-(4-morpholinyl)-1-propanone), BASF's Lucirin TPO (2,4,6-trimethylbenzoyldiphenyl phosphine oxide) are easily available on the market.

The thermal radical polymerization initiator includes, for example, organic peroxides and azo-type polymerization initiators. Examples of organic peroxides are benzoyl peroxide, lauroyl peroxide, acetyl peroxide, methyl ethyl ketone peroxide, cumene hydroperoxide, di-tert-butyl peroxide, tert-butyl perbenzoate, cyclohexanone peroxide. Examples of azo-type polymerization initiators are azobisisobutyronitrile, azobisvaleronitrile.

One or more different types of these chain-polymerization initiators may be used herein either singly or as combined.

Preferably, the chain-polymerization initiator is used in a ratio of from 0.5 to 5% by weight relative to the polymerizable compound having at least two (meth) acryl groups.

When the composition is photopolymerized with a photopolymerization initiator, for example, it is desirable that the composition is irradiated with light at a wavelength of from 300 nm to 500 nm at an intensity of from 1 mJ/cm²·sec to 1 J/cm²·sec for 30 seconds to 10 minutes.

When the composition is thermally polymerized with a thermal polymerization initiator, for example, it is desirable that the composition is heated at 80 to 150° C. for 1 minute to 10 minutes.

The chain polymerization in the invention may be a polymerization method of photopolymerization (e.g., UV irradiation), thermal polymerization (e.g., under heat) or radiation polymerization (e.g., with electron beams) not using a chain polymerization initiator.

In photopolymerization through direct irradiation with light not using a chain polymerization initiator, it is desirable that the composition is irradiated with short wavelength light at 250 nm or less at an intensity of at least 10 mJ.

In thermal polymerization under heat, it is desirable that the composition is heated at 120° C. or higher for 2 hours.

In radiation polymerization through irradiation with electron beams, it is desirable that the composition is irradiated with light at 10 mJ/cm²·s for 10 seconds to 2 minutes.

The composition in the invention may contain a substance for making the film have a function, not participating in polymer structure formation. The substance may be any of inorganic compounds or organic compounds, and is, for example, at least one selected from dye, pigment, metal fine particle, metal oxide fine particle, organic fine particle, organic low-molecular substance, organic polymer, dendrimer, biomolecule, carbon nanotube, fullerene, carbon black and clay mineral. Dye includes ordinary fluorescent dyes such as typically rhodamine, pyrene, porphyrin; and ordinary functional dyes such as azobenzene, spiropyran. Pigment includes polycyclic pigments such as azo pigment, phthalocyanine blue; and inorganic pigments such as nickel titanium yellow. Metal fine particle includes gold nanoparticles, silver nanoparticles, platinum particles, tungsten particles. Metal oxide fine particle includes aluminium oxide, titanium oxide, silicon oxide, tin oxide. Organic fine particle includes polystyrene latex, (meth)acrylamide particle, polystyrene fine particle polymerized with divinylbenzene. Organic low-molecular substance includes various functional molecules such as carbazole derivatives, TTF (tetrathiafulvalene) derivatives, quinone derivatives, thiophene and pyrrole derivatives. Organic polymer includes crystalline polymers such as polyethylene, polypropylene, polyamide; and amorphous polymers such as polystyrene, polycarbonate, polysulfone. Biomolecule includes DNA, protein, phospholipid, glucose, ATP. Clay mineral includes zeolite, kaolinite, montmorillonite, chlorite. Dendrimer includes PMMA-type dendrimer, thiophene-type dendrimer, poly(amidamine) dendrimer.

The substance may be in the composition for use in the invention, preferably in an amount of from 0.01 to 80% by weight. Also preferably, the substance is in the obtained polymer thin film in an amount of from 0.1 to 40% by weight.

As in the above, the production method of the invention may give a thin film that contains various substances. For example, the polymer thin film containing a dye may be used as an optical material. The polymer thin film containing a metal oxide may be used as an interlayer insulating film.

The composition for use in the invention may be prepared generally by adding resin and other substances to a solvent. The solvent to be used is not specifically defined. For example, for the solvent, usable are chloroform, cyclohexanone, diethylene glycol dimethyl ether, ethyl lactate, etc.

The composition in the invention is layerwise applied onto a support. The composition is layerwise polymerized to give one layer, and therefore, a polymer structure may be formed in one layer. Employing the technique makes it possible to produce a polymer thin film having an extremely increased strength as compared with conventional ones, and having self-supportability and a large surface area. Different types of polymer layers may be laminated.

The composition in the invention may be directly applied onto a support, or may be applied onto any other layer previously formed on a support, such as a sacrifice layer to be mentioned below.

Preferably, the surface of the support onto which the composition in the invention is applied is previously washed. For example, the surface may be washed with an acid-containing liquid, preferably a piranha solution. Employing the washing operation facilitates the separation of the polymerized resin composition (polymer thin film of the invention) from the support.

For layerwise providing the composition on a support, for example, employable is any ordinary layer-forming method of a spin-coating method or a dip-coating method.

In a spin-coating method, it is desirable that the support is spun at a revolution speed of from 600 to 8000 rpm.

The thickness of the film of the invention may be controlled by controlling the resin concentration in the film-forming composition and controlling the spin-coating condition.

The production method of the invention includes a step of separating the chain-polymerized composition from the support. For separating the chain-polymerized composition from the support, employable is any known separation method.

Preferably, a sacrifice layer is provided on the surface of a support, and the sacrifice layer is removed for the separation. The method of providing and removing the sacrifice layer may be any and every method not doing damage to the polymer thin film of the invention. Preferably, the composition-coated support is dipped in a solvent that dissolves only the sacrifice layer but does not dissolve the layer formed of the composition, or that is, the polymer thin film, whereby the sacrifice layer is dissolved away. When the method is employed, it is desirable that a cut is made into the interface between the sacrifice layer and the polymer thin film. Employing the technique is desirable as facilitating the penetration of the solvent into the sacrifice layer.

Especially in the invention, preferably used for the sacrifice layer is a polymer of such that it is originally insoluble in a solvent but becomes soluble in the solvent by some external stimulation give thereto. The polymer is preferably a crosslinkable polymer, more preferably thermo-crosslinkable photodegradable polymer or a photocrosslinkable thermo-degradable polymer. The thermo-crosslinkable photodegradable polymer includes, for example, a combination of a vinyl ether, a hydroxyl group-containing or acidic polymer and an optical acid generator. Concretely, for example, it includes those described in JP-A 9-274320, 2004-117878. On the other hand, the photocrosslinkable thermo-degradable polymer includes, for example, a polymer having an epoxy group in its side chains. Concretely, it includes those described in Chem. Mater. 2002, 14, 334-340. Employing the thermo-crosslinkable photodegradable polymer or the photocrosslinkable thermo-degradable polymer is advantageous in that almost all solvents may be used in providing the composition in the invention on a sacrifice layer.

In the invention, preferably employed is a method of using a water-soluble polymer as the main ingredient of the sacrifice layer and dissolving the sacrifice layer by the use of water. Using the sacrifice layer of the type is advantageous in that the thin film may be produced while it is floated and stretched on a water surface.

The main ingredient as referred to herein means that, for example, a water-soluble polymer accounts for at least 80% by weight of the sacrifice layer in preparation of the layer. The water-soluble polymer includes polystyrene sulfonate, polyvinyl alcohol, (meth)acrylamide, water-soluble cellulose.

The thickness of the sacrifice layer is preferably from 100 nm to 10 μm. Within the range, the sacrifice layer may be readily removed.

As the support, employable are glass, silicon wafer, mica, metal plate, etc. As the sacrifice layer, employable are polyhydroxystyrene, polystyrene sulfonate, resist material for semiconductor, thermal polymerizable polymer, etc. The solvent for use in forming the sacrifice layer is preferably one not doing damage to the polymer thin film of the invention. However, for example, for the case where the composition in the invention is layerwise provided after the solvent has been completely evaporated away, not overstepping the scope of the invention, this requirement is not indispensable.

The polymer thin film obtained according to the method of the invention has significant characteristics, which, however, films produced by conventional methods could not have.

First, the production method of the invention gives a self-supporting polymer thin film. “Self-supporting” as referred to herein means that the polymer thin film can still keep the shape of the thin film even after the substrate is removed from it.

Further, the method produces polymer thin films having the properties mentioned below.

(1) A polymer thin film still having self-supportability even though its thickness is reduced to 100 nm or less, further 30 nm or less.

(2) A polymer thin film having a surface area of 100 mm² or more.

(3) A polymer thin film having an aspect ratio (ratio of film size to film thickness) of 10⁴ or more, further 10⁶ or more, still further 10⁷ or more.

(4) A polymer thin film having excellent dimensional stability, concretely having a dimensional accuracy of 1% or less relative to the support.

(5) A polymer thin film having, for example, a strength of 1 MPa or more, further having a strength of 10 MPa or more.

(6) A polymer thin film capable of semi-permanently maintaining its self-supportability (for example, for 1 year or more).

(7) A polymer thin film having excellent flexibility, for example, having an ultimate expansion/contraction ratio of 0.1% or more.

(8) A polymer thin film in which the component derived from the polymerizable compound having at least two (meth) acryl groups accounts for from 20 to 99.9% by weight of the film.

(9) A polymer thin film having a Young's modulus of 800 MPa or more.

(10) A polymer thin film having a strength of 10 MPa or more.

Further, the polymer thin film obtained according to the production method of the invention has a sufficient mechanical strength which an non-polymerized linear polymer thin film and a polymer thin film with a polymerized structure formed between two layers could not have at all.

The thickness of the polymer thin film of the invention may be suitably determined depending on the use thereof. For example, it may be from 3 nm to 100 nm, preferably from 10 nm to 50 nm. Having the thickness falling within the range, the film may have flexibility that any other thick film could not have, and may therefore have increased substance permeability, and may be used as a tight protective film.

As described in the above, the polymer thin film of the invention may have a function by itself; but a functional layer may be additionally provided on the polymer thin film, or a functional material may be adhered to it to thereby make the film have a function. The functional layer includes a metal layer, a polymer layer, a metal oxide layer. The functional material includes dye (especially, functional group-having dye such as rhodamine isothiocyanate, fluorescamine, dansyl chloride, dabsyl chloride), pigment, liquid-crystal molecule, metal fine particle, semiconductor fine particle, oxide fine particle.

### EXAMPLES

The invention is described in more detail with reference to the following Examples, in which the material used, its amount and the ratio, the details of the treatment and the treatment process may be suitably modified or changed not overstepping the spirit and the scope of the invention. Accordingly, the invention should not be limitatively interpreted by the Examples mentioned below.

### Example 1

A polymerizable compound having two (meth)acryl groups (trade name: R280, produced by Mitsui Chemical) was dissolved in chloroform, and, as a photopolymerization initiator, Darocure 4265 (produced by Ciba-Geigy) was added thereto to prepare a coating solution. The concentration of the solution was so controlled that the polymerizable compound component could account for 0.2% by weight and that the photopolymerization initiator could be 5% by weight of the polymerizable compound component.

Chemical formulae of the polymerizable compound and the photopolymerization initiator are shown below.

### Darocure 4265:

This is a 1/1 (by weight) mixture of the following compounds:

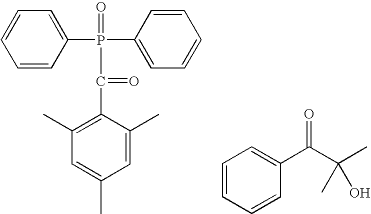

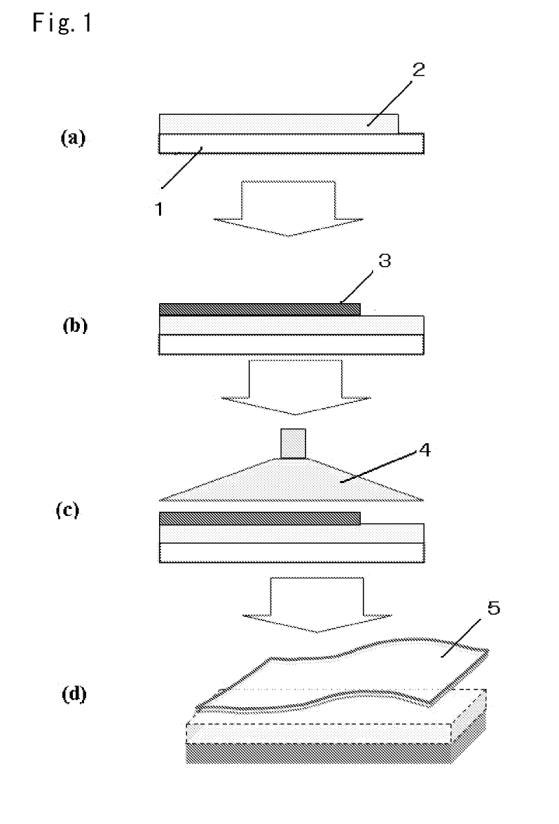

According to the process shown in FIG. 1, a polymer thin film was produced. In FIG. 1, 1 is a substrate, 2 is a sacrifice layer, 3 is a layer of the composition for use in the invention, 4 is a light exposure device, 5 is a polymer thin film formed of the composition after irradiation with light.

First, as a sacrifice layer, a polyvinylphenol (PHS) layer was provided on a silicon wafer substrate (size: 4×4 cm) according to a spin-coating method (thickness; about 100 nm) (FIG. 1A). Next, the above coating solution was applied onto it according to a spin coating method at 2000 rpm for 60 seconds, whereby a layer of the composition in the invention was provided on the sacrifice layer (FIG. 1B). The thickness of the layer was 20 nm. Using a light exposure device, the layer of the composition was exposed to light having a wavelength of 300 nm in vacuum for 30 seconds (FIG. 1C). In this, a mercury lamp was used as the light source, and the layer was exposed to light though a slide glass. The obtained polymer thin film was dipped in water, whereby the sacrifice layer was dissolved and the polymer thin film was separated (FIG. 1D).

The obtained polymer thin film was stable in water. In addition, the obtained polymer thin film had excellent dimensional stability, and its size was nearly the same as the size of the substrate.

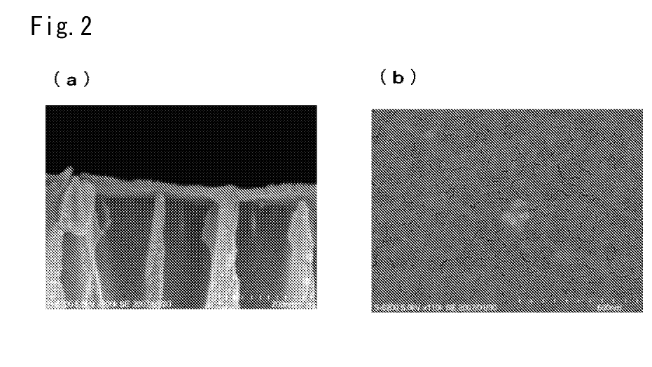

Scanning electronic microscopic (SEM) pictures of the obtained polymer thin film are shown in FIG. 2. In FIG. 2, A is a cross-sectional view; and B is a surface view. In observing it, the polymer thin film was transferred onto a porous alumina substrate. The thickness of the polymer thin film was about 22.2 nm. FIG. 28 confirms that the surface of the obtained polymer thin film was not damaged even after the film was transferred onto an alumina substrate having a rough surface. In FIG. 2B, the crack-like image indicates deposited platinum particles.

The size of the polymer thin film was 4 cm×4 cm.

The Young's modulus of the obtained polymer thin film was measured, according to a SIEBIMM method (strain-induced elastic buckling instability measurement method), and it was 800 MPa.

### Example 2

The same process as in Example 1 was carried out, in which, however, the polyvinylphenol (PHS) layer was changed to a polystyrenesulfonate (PSS) layer as the sacrifice layer.

Like in Example 1, the formed film was stable in water, and had excellent dimensional stability. The film had a size nearly the same as the size of the substrate. The thickness of the polymer thin film was about 22.2 nm. It was confirmed that the formed polymer thin film was not damaged.

### Example 3

The same process as in Example 1 was carried out, in which, however, ethanol was used in place of water for dissolving the sacrifice layer. After the sacrifice layer was dissolved with ethanol, a polymer thin film was obtained. However, in ethanol, the obtained polymer thin film could not be kept stable in ethanol. Concretely, immediately after the removal of the sacrifice layer, the polymer thin film existed while opened broadly, but soon it shrunk, and as a result, the film became a wrinkled ball-like aggregate. The aggregate was difficult to again open broadly.

### Example 4

The same process as in Example 1 was carried out, in which, however, Unidick 5500 (produced by Dai-Nippon Ink) was used in place of the commercial product R280 as the polymerizable compound having two (meth)acryl groups.

Like in Example 1, the formed film was stable in water, and had excellent dimensional stability. The film had a size nearly the same as the size of the substrate. The thickness of the polymer thin film was about 22.2 nm. It was confirmed that the formed polymer thin film was not damaged.

While the present invention has been described in detail and with reference to specific embodiments thereof, it will be apparent to one skilled in the art that various changes and modifications can be made therein without departing from the spirit and scope thereof.

The present disclosure relates to the subject matter contained in Japanese Patent Application No. 134000/2007 filed on May 21, 2007, which is expressly incorporated herein by reference in its entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A method for producing a polymer thin film, comprising:
providing a composition that contains a polymerizable compound having at least two (meth)acryl groups, on a support, to form a layer,
chain-polymerizing the polymerizable compound having at least two (meth)acryl groups in the layer, and separating the layer from the support.

2. The method for producing a polymer thin film according to claim 1, wherein the polymerizable compound having at least two (meth) acryl groups is represented by the following formula: 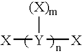
wherein Y represents a polyalcohol-modified group or an amine-modified group, n is an integer of at least 1, m is an integer of at least 0, and X is a group represented by the following formula: 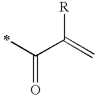
wherein R represents a hydrogen atom or a methyl group, and * indicates the site at which the group bonds to Y.

3. The method for producing a polymer thin film according to claim 1, wherein the composition further contains a chain polymerization initiator.

4. The method for producing a polymer thin film according to claim 1, wherein the chain polymerization is radical polymerization.

5. The method for producing a polymer thin film according to claim 1, wherein the composition has a viscosity, as measured with an E-type viscometer, of at least 0.01 cps.

6. The method for producing a polymer thin film according to claim 1, wherein the composition that contains a polymerizable compound having at least two (meth) acryl groups is layerwise provided on the support according to a spin-coating method or a dip-coating method.

7. A method for producing a polymer thin film, comprising:
providing a sacrifice layer on the surface of a support,
providing a composition that contains a polymerizable compound having at least two (meth)acryl groups, on the surface of the sacrifice layer, to form a layer,
chain-polymerizing the polymerizable compound having at least two (meth)acryl groups, and
removing the sacrifice layer to thereby separate the chain-polymerized layer from the support.

8. The method for producing a polymer thin film according to claim 7, wherein the removal of the sacrifice layer is attained by dissolving the sacrifice layer.

9. The method for producing a polymer thin film according to claim 8, wherein the sacrifice layer comprises a water-soluble polymer as a main ingredient, and the sacrifice layer is dissolved with water.

10. The method for producing a polymer thin film according to claim 9, wherein the water-soluble polymer is selected from the group consisting of polystyrene sulfonate, polyvinyl alcohol, (meth)acrylamide and water-soluble cellulose.

11. The method for producing a polymer thin film according to claim 7, wherein the polymerizable compound having at least two (meth) acryl groups is represented by the following formula: 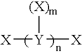
wherein Y represents a polyalcohol-modified group or an amine-modified group, n is an integer of at least 1, m is an integer of at least 0, and X is a group represented by the following formula: 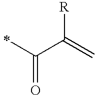
wherein R represents a hydrogen atom or a methyl group, and * indicates the site at which the group bonds to Y.

12. The method for producing a polymer thin film according to claim 7, wherein the composition further contains a chain polymerization initiator.

13. The method for producing a polymer thin film according to claim 7, wherein the chain polymerization is radical polymerization.

14. The method for producing a polymer thin film according to claim 7, wherein the composition has a viscosity, as measured with an E-type viscometer, of at least 0.01 cps.

15. The method for producing a polymer thin film according to claim 7, wherein the composition that contains a polymerizable compound having at least two (meth)acryl groups is layerwise provided on the support according to a spin-coating method or a dip-coating method.

16. A self-supportable polymer thin film having a thickness of 100 nm or less wherein the polymer is produced by chain-polymerizing a polymerizable compound having at least two (meth)acryl groups.

17. The self-supportable polymer thin film according to claim 16, which is produced by
providing a composition that contains a polymerizable compound having at least two (meth)acryl groups, on a support, to form a layer,
chain-polymerizing the polymerizable compound having at least two (meth)acryl groups in the layer, and
separating the layer from the support.

18. The self-supportable polymer thin film according to claim 16, which is produced by
providing a sacrifice layer on the surface of a support,
providing a composition that contains a polymerizable compound having at least two (meth) acryl groups, on the surface of the sacrifice layer, to form a layer,
chain-polymerizing the polymerizable compound having at least two (meth)acryl groups, and
removing the sacrifice layer to thereby separate the chain-polymerized layer from the support.

19. The self-supportable polymer thin film according to claim 16, which has a thickness of 30 nm or less.

20. The self-supportable polymer thin film according to claim 16, which has an aspect ratio of the film size to the film thickness of at least 10⁴.
